(19) United States
(12) Patent Application Publication
(10) Pub. No.: US 2005/0279678 A1
(43) Pub. Date: Dec. 22, 2005

(54) System for removing mercury and mercuric compounds from dental wastes

(76) Inventors: Allan Carlson, Evergreen, CO (US); David G. Beall, Centennial, CO (US); Amanda K. Kimball, Lakewood, CO (US); Craig S. Turchi, Lakewood, CO (US); Bradley D. Veatch, Westminster, CO (US)

Correspondence Address: SHERIDAN ROSS PC, 1560 BROADWAY, SUITE 1200, DENVER, CO, 80202, US

(21) Appl. No.: 10/957,445

(22) Filed: Oct. 1, 2004

Related U.S. Application Data
(60) Provisional application No. 60/508,181, filed on Oct. 1, 2003.
(60) Provisional application No. 60/547,125, filed on Feb. 23, 2004.
(60) Provisional application No. 60/584,536, filed on Jun. 30, 2004.

(51) Int. Cl. B01D 29/88

(52) U.S. Cl. 210/97

(57) ABSTRACT

The present invention is directed to a system for removing amalgam particles and/or dissolved metals, such as mercury and silver from dental effluents. The system can include one or more of a particle collection device and a dual-purpose line cleanser.

### CROSS REFERENCE TO RELATED APPLICATION

The present application claims the benefits of U.S. Provisional Application Ser. Nos. 60/508,181, filed Oct. 1, 2003; 60/547,125, filed Feb. 23, 2004; and 60/584,536, filed Jun. 30, 2004, all of which are incorporated herein by reference in their entireties.

### NOTIFICATION OF FEDERAL RIGHTS

This invention was made with Government support under Grant Nos. NIH 2 R43 DE14010-02 and NIH 1 R43 DE13993-01 awarded by the National Institute of Health. The government has certain rights in the invention.

### FIELD OF THE INVENTION

The present invention relates generally to removing mercury and mercury-containing compounds from liquid wastes and specifically to removing mercury and mercury-containing compounds from dental waste streams.

### BACKGROUND OF THE INVENTION

Dental evacuation (e.g., suction and vacuum) systems are used to remove solids and liquids from the patient's mouth during dental procedures. These systems typically include a suction hand piece attached to a flexible tube at each dental chair. Suction is generated by a central vacuum pump. The solids, liquids, and air drawn into the evacuation system by a liquid collection device, such as the suction tube, a sink, or evacuation line, are normally discharged to the municipal sewer system. Materials drawn into this system can include saliva, blood, mouthwash, pieces of tooth, bone, tissue, and dental restorative or implant materials, such as dental amalgam.

Dental amalgam is an amalgam of mercury, silver, copper, tin, and other potentially harmful trace metals. Amalgam fillings typically contain about 50% mercury by weight. Each year tens of thousands of pounds of mercury-containing wastes are discharged by dental offices into municipal waste systems. Mercury is a known environmental contaminant, classified by the USEPA as a persistent, bioaccumulative, and toxic material. Waste water treatment plants must meet strict limits on the amount of mercury they can release. The mercury discharged by dental offices is typically in violation of applicable environmental regulations.

Amalgam separators are used to remove amalgam particles from dental wastes before discharge into the municipal sewer system. The devices can be simple filters, sedimentation-style devices, or more complicated centrifuges. Examples of such devices are described in U.S. Pat. Nos. 5,885,076; 5,797,742; 5,795,159; 5,577,910; 5,227,053; 5,114,578; 5,018,971; 4,753,632; 4,591,437; and 4,385,891; and U.S. Patent Application 2001/0047956A1, all of which are incorporated herein by this reference.

A common amalgam separator design is a sedimentation-style device. In such systems, the dental waste stream is placed in a quiescent settling area so that the particles may gravity separate from the liquid. Although such devices can be simpler and cheaper than other designs, the devices nonetheless can have problems. For example, some devices fail to ensure adequate settling time for effective solid/liquid separation and/or discharge the supernatant water in a manner that disturbs the settled materials. Sedimentation-style devices are relatively large to collect and hold the daily wastewater.

Although particle removal systems, such as sedimentation-style devices, may remove mercury-containing particles, they often are unable to remove dissolved mercury and mercury-containing compounds. Mercury and other heavy metals are present in dental wastewater in three primary forms, namely as easily removed large amalgam particles and hard-to-remove small colloidal particles and microscopic soluble species. Basic amalgam separators are generally ineffective in removing colloidal particles and solubilized metals. Efforts designed to capture these constituents of dental waste streams generally include the use of microfiltration and solid adsorbent materials. These approaches can be expensive, cumbersome, and prone to fouling.

To make matters worse, cleaners for dental vacuum systems can increase waste stream discharge levels of colloidal particles and soluble metals. Typical dental line cleansers contain surfactants and disinfectants and may range in pH from acidic to highly basic. Active ingredients include sodium hydroxide (Alprojet™), chloramine T (Tiutol™ and Aseptoclean 2™), sodium perborate or another percarbonate, hydrogen peroxide (Orotol Ultra™), ammonium chloride (S&M matic™ and Vacusol™), sodium hypochlorite (bleach), pyridine compounds (Green & Clean™), phosphoric acid (Purevac™), glycolic acid, citric acid, isopropanol, chlorhexidine gluconate (Biovac™), and/or enzymes (Vacukleen™). These cleaners can react with and cause metals in particle or amalgam form to enter solution, thereby raising the concentration of solubilized metals.

### SUMMARY OF THE INVENTION

These and other needs are addressed by the various embodiments of the present invention. The present invention provides a separation method and apparatus that uses the state of the vacuum pump to control discharge of the liquid phase of the collected waste stream and a line cleanser formulation that comprises aggregating and precipitating agents to effect removal of colloidal and dissolved forms of mercury.

In one embodiment, the particle collection device has bimodal operation. In one mode, at least most (more than half) of the air phase, but little, of any, of the solid and liquid phases, are removed from the collection device along a first path of flow. In another mode, at least most (more than half) of liquid phase, a small portion (less than half) of the gas but little, if any, of the solid phase, are removed along a different second path of flow. A valve, such as a diaphragm or piston valve, is triggered after a liquid level in the device reaches a predetermined height and/or after passage of a predetermined sedimentation time and/or cycling of the vacuum pump from off to on. In response, the valve blocks the first path of gas flow and thereby forces the liquid phase in the collection vessel, for a controlled and limited amount of time, to follow the second path of flow. The existing vacuum pump, and not an additional pump, removes the gas phase in the former operational mode and the liquid phase in the latter operational mode.

The ability of the collection devices to temporarily use the full power of the vacuum pump to extract supernatant liquid from the collection vessel is highly beneficial. Because the vacuum pump is used, the liquid phase can be withdrawn through a filter or filter/adsorbent media, thereby providing additional capture beyond simple sedimentation. This effectively allows a filter or filter/adsorbent media to be inserted into the second path of flow during liquid phase discharge and removed from the flow path for normal dental office operation. Having the filter/adsorbent media permanently in the flow path during normal operation is not feasible because it could create too high of a pressure drop, particularly as the collection vessel accumulates solids. The inclusion of the filter in the liquid phase removal flow path provides backup particle separation when insufficient settling time is provided and allows the device to be physically smaller than designs without a filter. The collection vessel further separates the gas phase from the liquid and solid phases at the inlet to the device. This allows the gas phase to flow unimpeded to the vacuum pump, thereby creating very little pressure drop in the dental office vacuum system.

In one embodiment, the line cleanser is dual purpose in that it not only cleans the vacuum system components but also enhances capture of colloidal and solubilized forms of mercury. Combined with a particle collection device, such as those discussed herein, the line cleanser captures colloidal and solubilized forms of mercury. Soluble forms of mercury are precipitated by a precipitating agent to form colloidal particles, and at least most of the colloidal particles are agglomerated by an agglomerating agent to a separable size. Soluble forms of mercury are further limited in concentration by controlling the pH and Eh of the waste stream. The particle collection device then captures a high percentage of the amalgam particles. The device typically captures or collects at least most and more typically at least about 95% of all amalgam particles that are about 10 microns or greater in size. The collection device can be recycled or disposed of. For example, the collection device can be operated for a predetermined period (typically 6-12 months) after which the device is replaced. The used device is shipped to a recycling facility to recover the captured amalgam particles and/or elemental and speciated mercury.

### BRIEF DESCRIPTION OF THE DRAWINGS

FIG. 1 is a flow schematic of an embodiment of the present invention;

FIG. 2A is a cut-away view of a sedimentation-style device according to an embodiment of the present invention;

FIG. 2B is a disassembled view of the sedimentation-style device of FIG. 2A;

FIG. 3A plan view of a diaphragm valve body in a valve assembly of the embodiment of FIG. 2;

FIG. 3B is a cross-sectional view along line 3B-3B of FIG. 3A;

FIG. 3C is a disassembled view of an outlet valve assembly;

FIG. 3D is an isometric view of the outlet valve assembly;

FIG. 3E shows the outlet valve assembly in an open position;

FIG. 3F shows the outlet valve assembly in a closed position;

FIG. 4A is an isometric view of a filter assembly according to the embodiment of FIG. 2;

FIG. 4B is a dissembled view of the filter assembly of FIG. 5A;

FIG. 5A is a first disassembled view of an inlet port assembly according to the embodiment of FIG. 2;

FIG. 5B is a second disassembled view of the inlet port assembly;

FIG. 5C is a assembled view of the inlet port assembly;

FIG. 5D is a cross-sectional view of the inlet port assembly;

FIG. 6A is a disassembled view of a chamber assembly in the embodiment of FIG. 2;

FIG. 6B is a partially disassembled view of the chamber assembly;

FIG. 6C is an isometric view of the chamber assembly;

FIG. 7A is cross-sectional view of a sedimentation-style device according to a second embodiment of the present invention;

FIG. 7B is a side view of a top and bottom plate of the device of FIG. 7A;

FIG. 7C is a top view of a top and bottom plate of the device of FIG. 7A;

FIG. 7D is a top view of the device of FIG. 7A;

FIG. 8A is a cross-sectional view of a sedimentation-style device according to a third embodiment of the present invention;

FIG. 8B is a top view of the device of FIG. 8A;

FIG. 8C is a bottom view of the device of FIG. 8A with the bottom plate removed;

FIG. 9 is a flow chart depicting the operation of a controller in the device of the embodiment of FIG. 9A;

FIG. 10 is a plot of mercury concentration (ppb) (vertical axis) against reagent (horizontal axis);

FIG. 11 is a plot of mercury concentration (ppb) (vertical axis) against dental test clinic identifier (horizontal axis);

FIG. 12 is a plot of mercury concentration (ppb) (vertical axis) against pH (horizontal axis) for a quaternary ammonium salt additive;

FIG. 13 is a plot of total mercury (ppb) (vertical axis) against dental test clinic identifier (horizontal axis); and

FIG. 14 is a plot of total mercury (ppb) (vertical axis) against dental test clinic identifier (horizontal axis).

### DETAILED DESCRIPTION

### The Combined Mercury Removal System

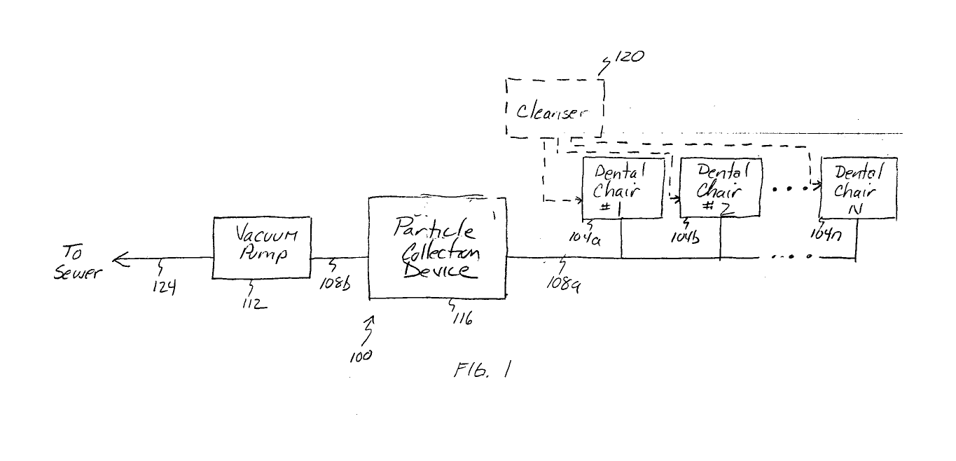

FIG. 1 shows a combined mercury removal system according to the present invention. The system 100 includes a plurality of dental chairs 104a-n, vacuum lines 108a and b, vacuum pump 112, particle collection device 116, and a cleanser 120.

The collection device 116 can be of a variety of configurations, including those discussed below. Preferably, the device 116 is a sedimentation-style device that uses gravity settling techniques to effect separation of the liquid and solid fractions of the incoming dental waste stream. The device 116 is preferentially located between the vacuum line 108a to the chairs 104a-n and the vacuum line 108b to the vacuum pump 112. Thus, the device 116 is typically installed on the suction side of the vacuum pump 112, preferably close to the vacuum pump. An exhaust hose 124 to the sewer (not shown) is connected to the vacuum pump 124.

The cleanser may be administered at any point in the system 100. Preferably and as shown in FIG. 1, the cleanser 120 is introduced into the system 100 through the vacuum lines 108a on a periodic basis. More preferably, the cleanser 120 is aspirated using the vacuum hand piece (not shown) at one or more of the dental chairs 104a-n. The cleanser 120 is preferably introduced as a diluted version of a concentrated cleanser, and a portion of the cleanser is added at each of the vacuum hand pieces. The cleanser 120 flows through the vacuum lines 108, flushing the lines, and eventually being collected in the device 116. In a preferred formulation, the cleanser 120, inter alia, agglomerates colloidal particles and precipitates dissolved metals, such as mercury.

As will be appreciated, the cleanser 120 may alternatively be introduced through a port in the device 116. Alternatively, the cleanser 120 maybe included within the device 120 as a timed-release capsule or tablet. Although realizing the purpose of mercury capture, these approaches circumvent the purpose of cleaning the vacuum lines.

### The Particle Collection Device

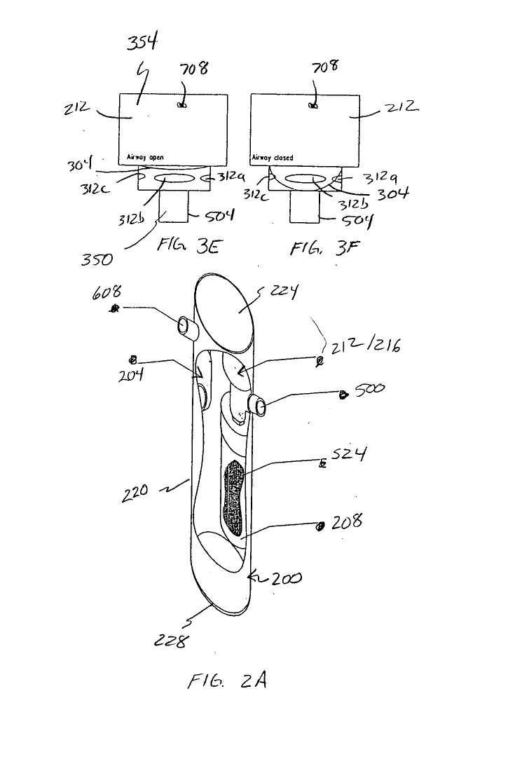

A first embodiment of a particle collection device 116 is shown in FIGS. 2A-B, 3A-F, 4A-B, 5A-D, and 6A-C. The particle collection device includes a collection vessel 200, an inlet port assembly 204, a filtration assembly 208, a chamber assembly 212, and an outlet valve assembly 216.

As shown in FIG. 2A-B, the collection vessel 200 includes a cylindrical housing 220 engaging a top cap 225 and bottom plate 228. The collection vessel 200 collects mercury-containing and other particles and effects gravity separation of the particle and liquid fractions of the input waste stream.

As shown in FIGS. 2A and 5A-D, the inlet port assembly 204 includes first and second elbows 600 and 604, an inlet 608, and a connecting rod 612. As can be seen from FIG. 5D, the first elbow 600 is a 90° elbow and the second elbow 604 a 45° elbow. The 135° change in input flow direction dampens the high velocity three-phase input waste stream 620 (which three phases are gas, liquid, and solid phases). In other words, the high velocity stream 620 is redirected towards the housing wall 220. The impact of the stream 620 against the wall 220 causes separation of the gas phase from the remaining solid and liquid phases and prevents the stream from directly impacting the outlet valve and filtration assemblies and from reaching the gas flow/liquid overflow mechanism described below.

The two elbows (604 and 680) are connected by a rod 612 through holes 618. The holes in elbow 600 are larger than the holes in elbow 604 so that, when the rod is glued to elbow 604, elbow 604 will still dangle from (or be movably or rotatably mounted on) elbow 600. This dangling or muffler also acts to dampen the flow into the chamber.

As shown in FIGS. 2A-B and 4A-B, the filtration assembly 208 includes a housing outlet 500, a “T” fitting 504, a reducer bushing 508, a flow restrictor 512, a conduit 516, a filter shroud cap 520, a filter cartridge 524, a filter end plug 528 that is received in the central passage 550 of the filter cartridge 524, and a filtration chamber body 532. The “T” fitting 504 includes a first outlet 536 that communicates with the housing outlet 500 and a second outlet 540 that communicates with the outlet valve assembly 216. As discussed below, when supernatant liquid is removed by the vacuum pump 112 from the device 116, the liquid is drawn through the filter cartridge 524. The filter cartridge 524 is pore sized so that it retains particles that are too small to settle in the waste stream collected in the exterior housing 200 and also acts as a counter measure to ensure that, when the pump is turned off and on again during too short a time interval, the particles that have not yet had sufficient time to settle are not discharged from the housing.

The restrictor 512 decreases the otherwise high flow rate associated with the vacuum pump 112. This prevents larger particles from being pulled through the filter 524. Preferably, the velocity in the conduit 516 is decreased by from about 5 to about 20% relative to the unrestricted flow velocity. To effect this decrease, the restrictor 512 preferably has an orifice size that is from about 1% to about 10% of the inner diameter of the conduit 516. Even more preferably, the orifice size ranges from about 1/16″ to about ¼″.

The filtration cartridge 524 is selected so as to remove at least most and more preferably at least about 90% of the entrained particles from the filtrate. The filtration cartridge 524 preferably has a pore size ranging from about 0.1 to about 20 microns, more preferably from about 0.25 to about 10 microns, and even more preferably from about 0.35 to about 5 microns. The filtration assembly can include one or more absorbents, such as activated carbon, and/or sulfur-impregnated carbon, and/or ion exchange materials such as cellulosic resins, chelating resins, porous silica, zeolites, thioronium, and/or thiol-based resins, to assist with the capture of dissolved metals. A particularly preferred filtration cartridge is a 9⅞″ long, 0.35-micron pleated filter filtration cartridge sold under the tradename Harmsco Model 801-0.35™ The filtration chamber body 532 surrounds at least substantially the filtration cartridge 524, inhibits air bypass, thereby avoiding incomplete evacuation of the supernatant liquid, and causes the liquid to be drawn through the entire length of the cartridge 524. Thus, the body 532 inhibits liquid passing only through the bottom of the cartridge 524 and thereby avoids problems with clogging at the cartridge 524 bottom.

As shown in FIGS. 2A-B and 6A-C, the chamber assembly 212 includes a chamber cap 700, an orifice 708 and a chamber body 704. The orifice 708 extends through the housing 212 and cap 704 and restricts air flow between vessel body 220 and the chamber defined by the chamber assembly 212. This restriction delays pressure equilibration between housing 220 and chamber assembly 212. When vacuum pump 112 is activated after a period of being off, vessel 220 is quickly reduced below atmospheric pressure, while chamber 212 remains temporarily at atmospheric pressure. As noted below, the pressure differential causes a diaphragm in the outlet valve assembly 216 to close the valve assembly 216 when the vacuum pump is activated.

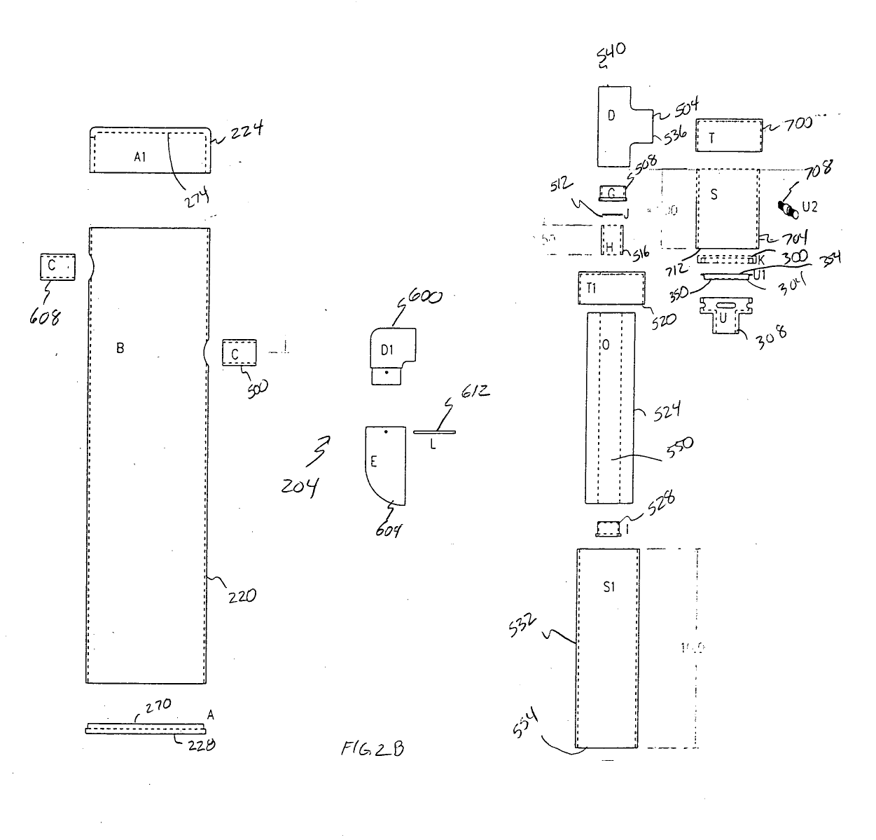

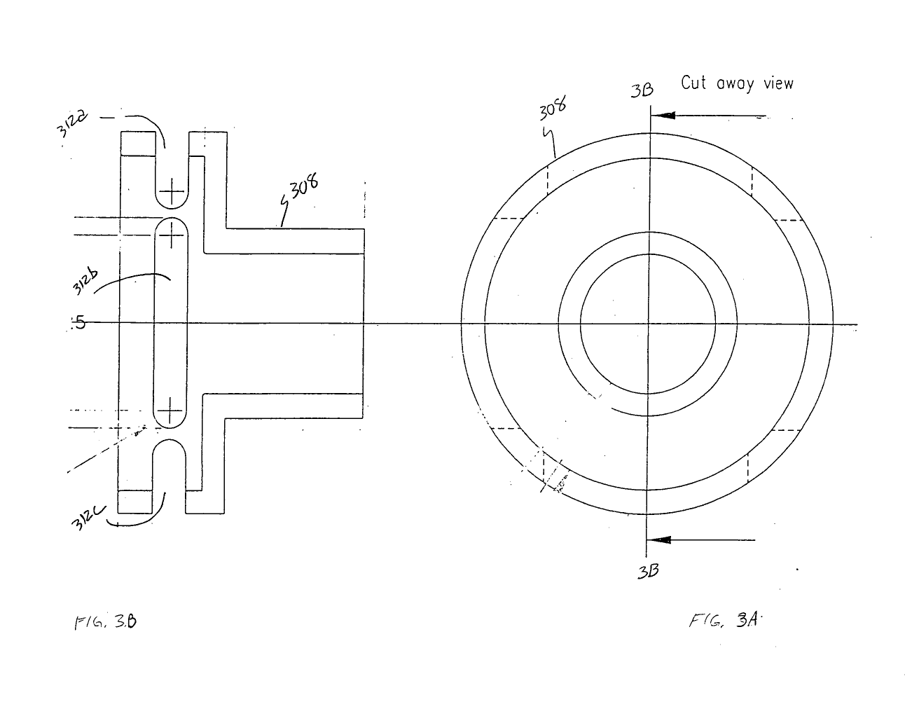

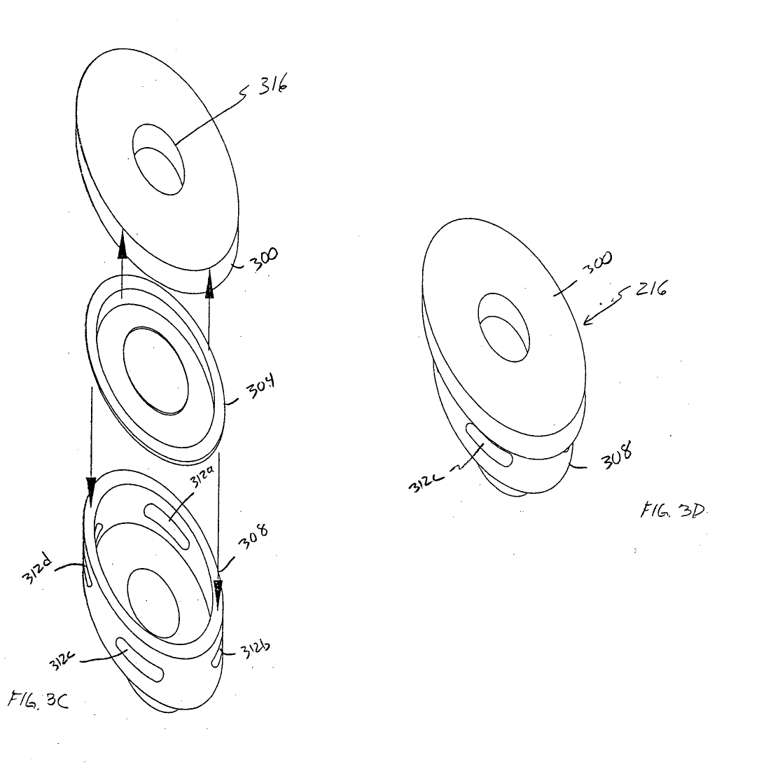

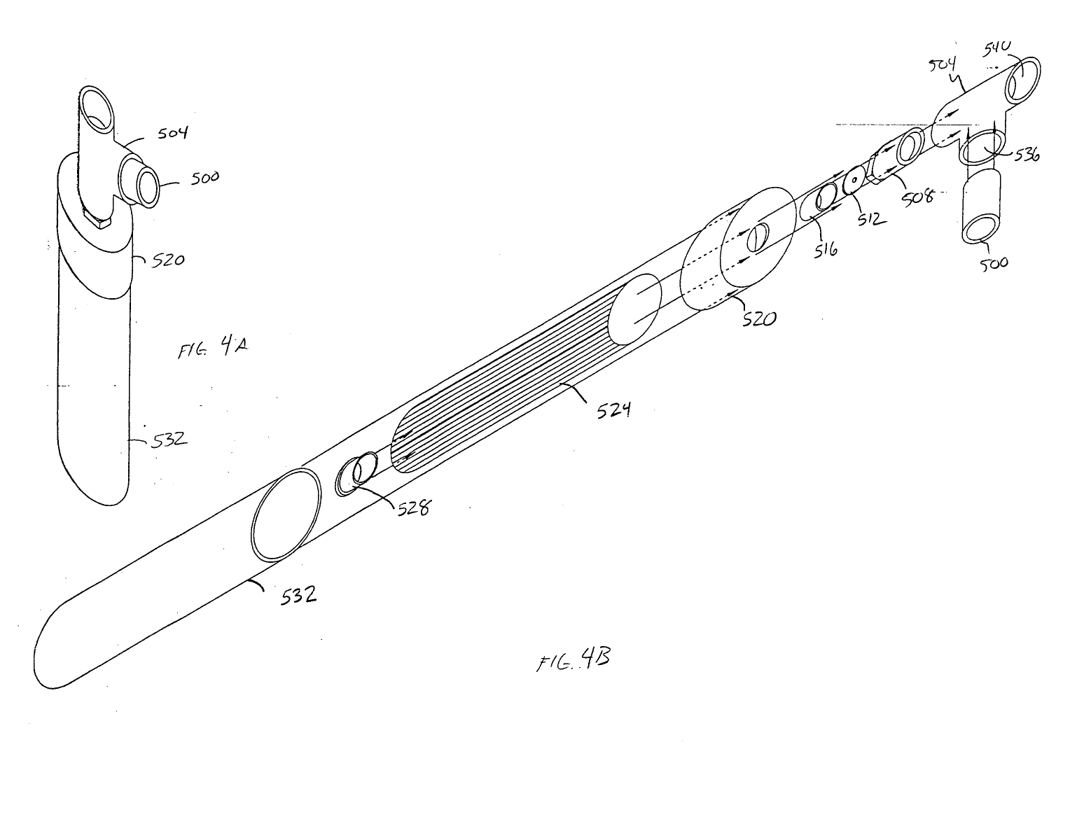

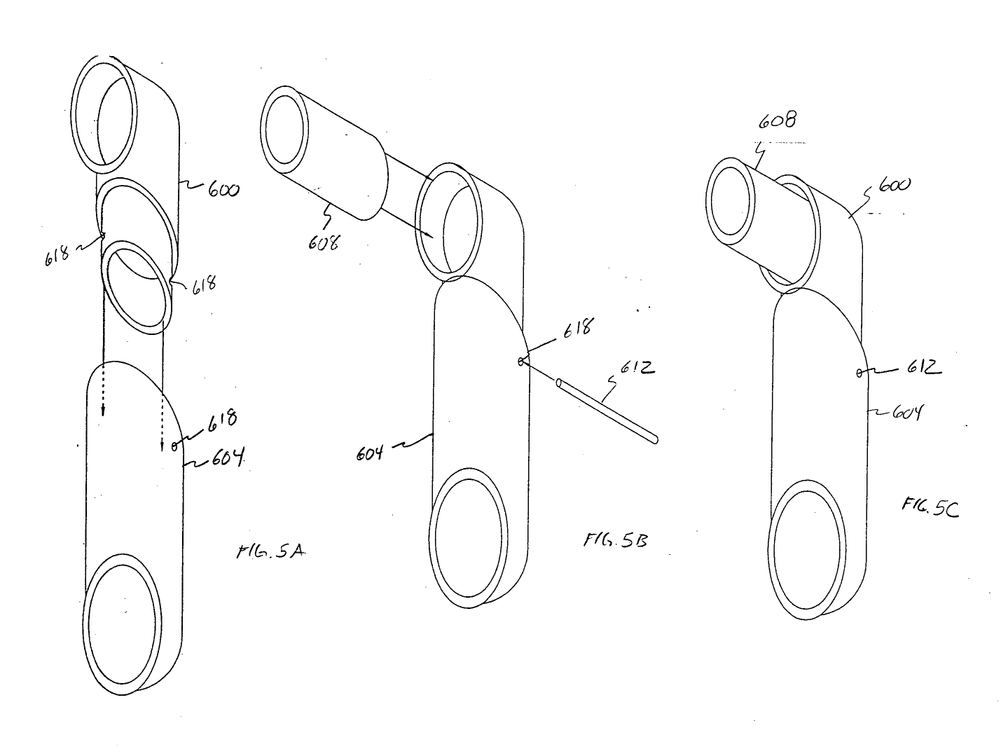

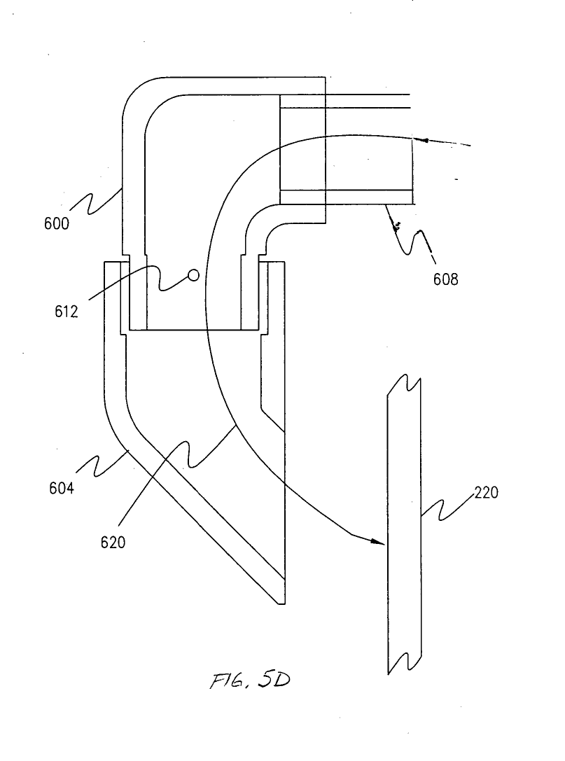

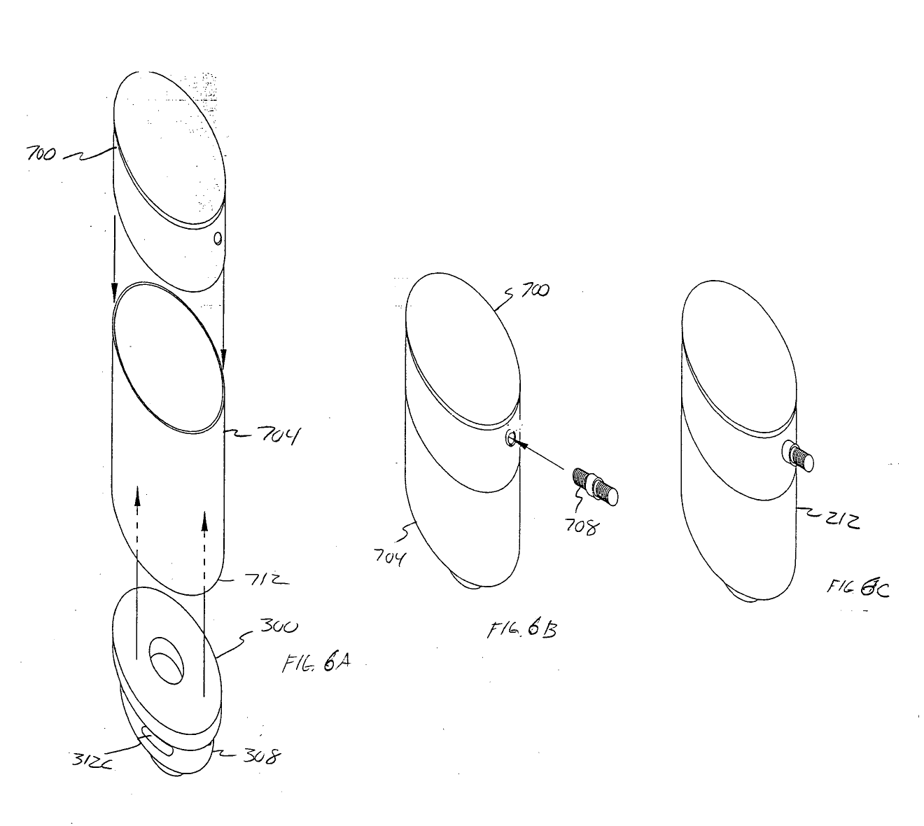

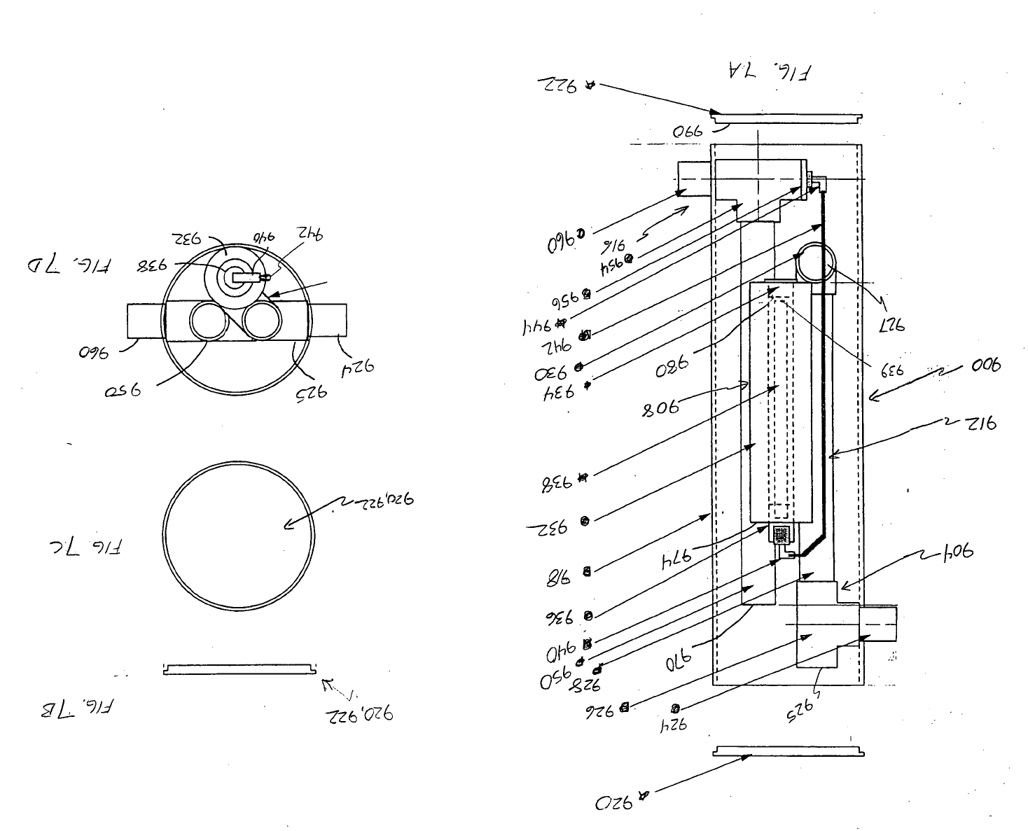

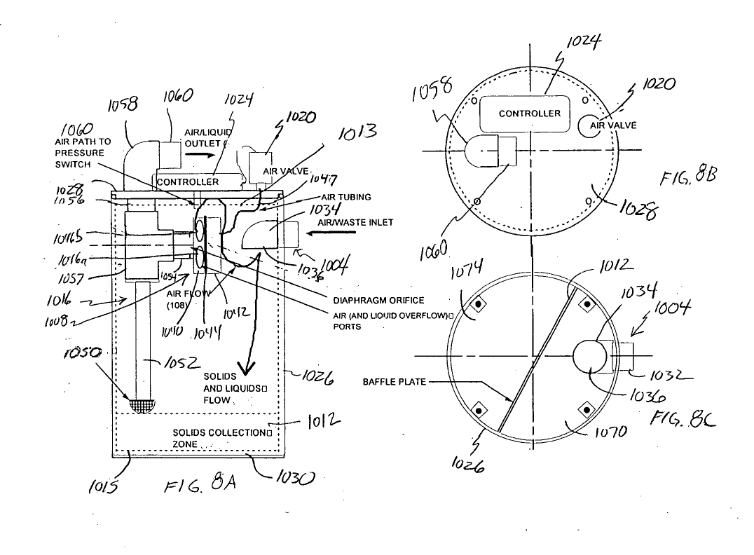

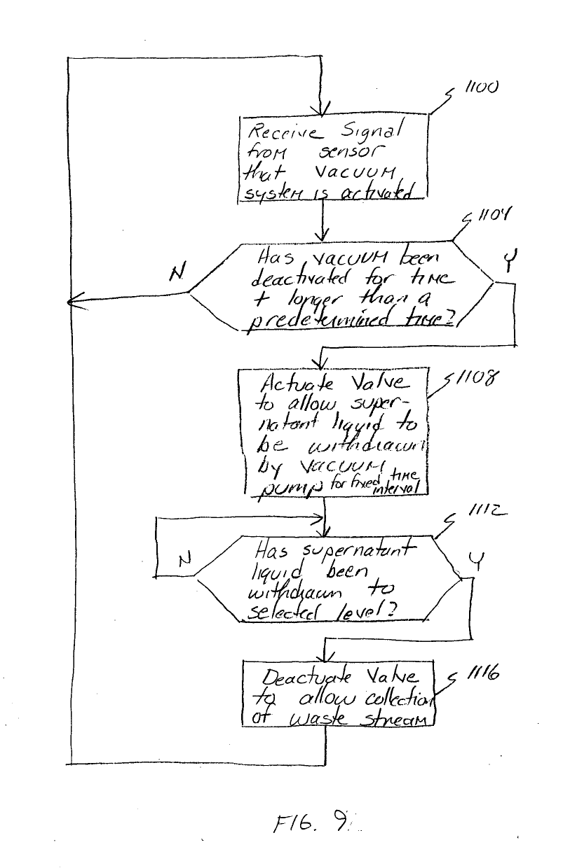

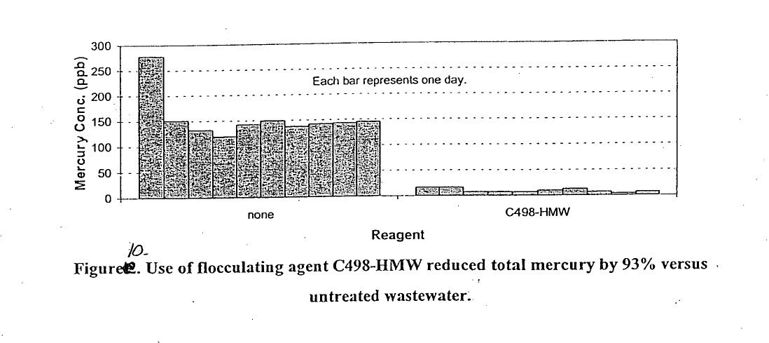

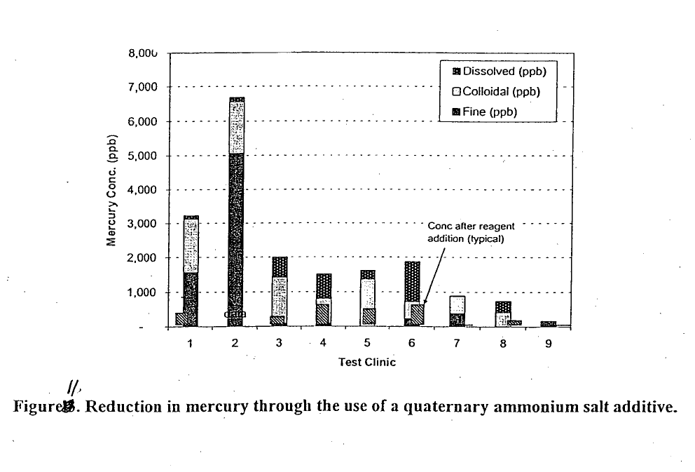

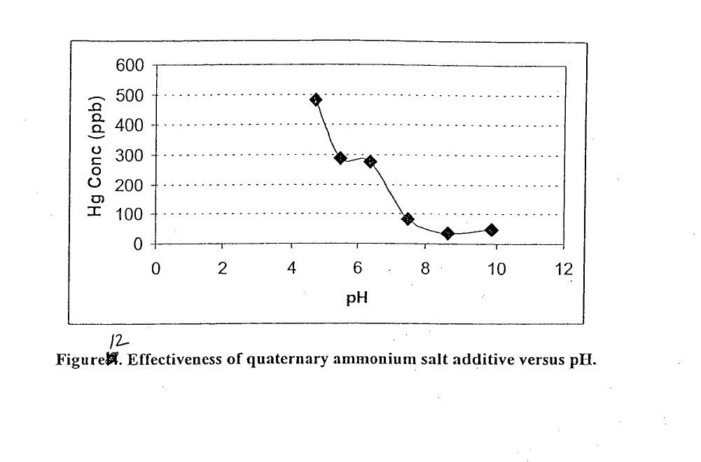

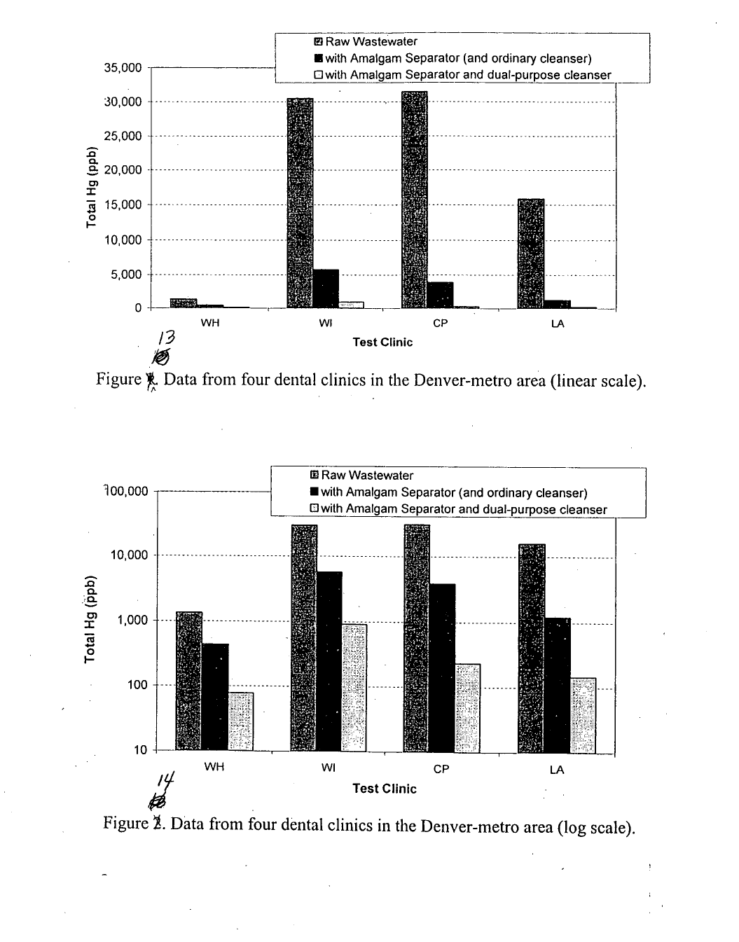

As shown in FIGS. 2A-B and 3A-F, the outlet valve assembly 216 includes an adapter disk 300 to engage the lower end 712 of the chamber body 704, a silicone (flexible and resilient) diaphragm 304, and a valve diaphragm holder 308. As can be seen in FIGS. 3A and B, the holder 308 includes a plurality of ports 312a-d for negative pressure air contained inside the housing 220. The adapter disk 300 includes a central passage 316 for air contained inside the chamber assembly 212 to contact the adjacent surface of the flexible diaphragm. When the vacuum pump is activated, the negative pressure air exits the housing 220 through the ports 312a-d and the outlet 500 and subsequently the diaphragm 304, due to the unequal pressure on the two sides of the diaphragm (negative pressure in the housing 220 and atmospheric pressure in the chamber body 704) expands to close the input passageway 540, effectively closing ports 312a-d, which causes liquid to be drawn through the open bottom 554 of the filtration chamber body 532, and out passageway 500.

As shown in FIG. 3E, the diaphragm 304 is selected so that it closes the passageway 540 312a-d under the pressure force of the atmospheric pressure on the high pressure side 354 and the vacuum pressure on the lower pressure side 350 when the vacuum pump 112 is activated. The diaphragm is activated preferably by a pressure differential of about 1.0 to about 15 psi and preferably from about 3.5 to about 7.5 psi. To provide this behavior, the diaphragm elasticity preferably falls within the range of about 10 to about 70 and more preferably 15 to 50 shore A durometer. The preferred diaphragm designed by ADA Technologies, Inc., is shown in FIG. 3C and ranges in thickness from about 1/64 to about ⅛ inches and more preferably from about 1/32 to about ⅛ inches.

The bimodal operation of the device will now be discussed with reference to FIGS. 2A-B, 3A-F, 4A-B, 5A-D, and 6A-C.

In a first mode when the vacuum pump 112 is on, the waste stream from the vacuum hand piece(s) at one or more of the dental chairs 104a-n is drawn through the vacuum line 108a and the inlet port assembly 204 and into the collection vessel 200. As noted, the high pressure stream, due to the direction of the outlet from the second elbow 604, will splatter against the adjacent wall of the housing 220. The liquid and solid phases of the stream will flow into the lower portion of the vessel 200 and the air phase will rise to the upper portion of the vessel 200 to be drawn through the ports 312a-d and outlet 500 to the vacuum line 108b. As the slurry fills the lower portion of the vessel 200, solid particles settle to the bottom of the vessel 200 via sedimentation.

The device enters into the second operational mode in response to activation of the vacuum pump 112 as noted above. In response, the diaphragm expands downwards as shown in FIG. 3F to close the passageway 540. This closure causes the liquid to be drawn through the filter cartridge 524 and into the passage 550, through the conduit 516, the flow restrictor 512, the reducer bushing 508, the “T” fitting 504, and the outlet port 500 to the vacuum line 108b. As pressure in the chamber assembly 212 approaches equilibrium relative to the vacuum pressure in the vessel 220, the resistive force of the diaphragm overcomes the pressure differential to reopen gradually the passageway 540 and the ports 312a-d as shown in FIG. 3E, thereby causing air and not liquid to again be drawn to and through the outlet port 500.

As will be appreciated in the first mode, the height of the liquid above the outlet 500 causes adequate pressure drop to allow liquid to flow out through filter cartridge 524 and into passage 550, conduit 516, flow restrictor 512, reducer bushing 508, “T” fitting 504, and the outlet port 500 rather than overflowing through ports 312a-d with no filtration or sedimentation. The volume between port 500 and ports 312a-d can fill and slowly trickle out through the filter 524 without the force of the vacuum pump 112. This allows for some error in the calculation for total volume of the collection vessel 220.

The height of the bottom of the cartridge 554 to ports 312a-d defines the volume of liquid and solids that can be collected between discharge events without overflowing the collector. This height is typically selected so that liquid and solids will collect in the vessel for a period of about one day. Inlet port assembly 204 and outlet air/overflow ports 312a-d are oriented such that, if overflow should occur, some particle separation will be achieved. In one configuration, the volume of the cylinder between the bottom 554 of the body 532 and upper surface 270 of the bottom plate 225 is sized to contain the estimated collected solids volume for the operational life of the device (e.g., one year) and ranges from about 1 to about 4 liters. Stated another way, the height of the bottom of the cartridge 554 above the upper surface 270 is typically from about 10 to about 20% of the total distance between the upper surface 270 of the bottom plate 228 and the lower surface 274 of the cap 224.

The passageway sizes in the outlet port assembly are sufficient to create less than about 2% drop in airflow when installed in a vacuum system while flow restrictor 512 is sized to provide a consistent liquid emptying rate over a range of likely vacuum pump settings. The rate of flow can be an important factor as it preferably is fast enough to empty the collection vessel before the dental office begins operations that would introduce more dental waste stream into the vessel but not so fast as to draw settled particles from the bottom of the vessel. The preferred restriction time ranges from about 1 to about 10 minutes and more preferably from about 1 to about 3 minutes. The preferred liquid discharge or flow rate ranges from about 2 to about 4 liters/minute.

A second embodiment of a particle collection device 116 is shown in FIGS. 7A-D. The particle collection device includes a collection vessel 900, an inlet port assembly 904, a filtration assembly 908, a siphon assembly 912, and an outlet port assembly 916.

The collection vessel 900 includes a body housing 918, and top and bottom plates 920 and 922. When assembled and connected to the vacuum lines 108, the collection vessel 900 is sealed from the ambient atmosphere.

The inlet port assembly 904 includes an inlet 924 passing through the vessel 900 and connected to the vacuum line 108a, a “T” fitting 926, an elongated conduit 928, and a 90° elbow 930. When the three-phase waste stream enters the inlet 924 from the vacuum line 108a, the gas phase exits through the outlet 925 of the “T” fitting 926 and the liquid and solid/particle phases exit through the outlet 927 of the elbow 930.

The filtration assembly 908 includes a filter cartridge 932, lower and upper filter end plugs 934 and 936, and a conduit 938 positioned in the cylindrical central passageway running through the center of the filter cartridge 932. The conduit 938 is open at the bottom 939 just above the lower filter end plug 934 and engages the upper filter end plug 936 to pass liquid through the filter cartridge 932. As will be appreciated, the lower end plug 934 differs from the upper end plug 936 in blocking fluid flow and not having a central passageway for filtered liquid or supernatant.

The siphon assembly 912 includes a first 90° elbow 940 engaging the upper end plug 936, a second elbow 944 engaging the outlet port assembly 916, and a length of tubing 942 engaging each of the first and second elbows 940 and 944.

The outlet port assembly 916 includes a length of conduit 950 engaging a “T” fitting 954, an end plug 956 engaging the “T” fitting 954 and second elbow 944 of the siphon assembly 912 and providing a passageway for the siphoned supernatant, and an outlet 960 engaging the “T” fitting 954 and passing through the housing 918 and engaging the vacuum line 108b. The outlet 960 must be below the open end 939 of the conduit 938 for siphoning to occur.

Like the device of the first embodiment, this device operates in two different modes.

In a first mode, the dental waste stream enters the inlet 924. The gas phase exits through the outlet 925 and the liquid and solid phases through the outlet 927. The gas phase is then drawn by the vacuum pump 112 through the open end 970 of the conduit 950 and exits the device by means of the outlet 960. Liquids and solids gradually accumulate in the bottom portion of the vessel 900 until the liquid level submerges the filter cartridge 932 and rises to the top of the fitting 940. At that point, the device begins to operate in the second mode.

In the second mode, a siphoning action in the siphon assembly 912 starts. Supernatant liquid is drawn through the filter cartridge 932 and conduit 938, the siphon assembly 912, and the “T” fitting 954 to be discharged by the outlet 960. The siphon action stops when the liquid level drops below the bottom 939 of the conduit 938. At that point, the device commences operating in the first mode again. This process is repeated as the vessel 900 fills and empties. As will be appreciated, the distance from the port 939 of the conduit 938 to the top of fitting 940 determines directly the frequency at which the device switches from the first mode to the second mode and therefore the particle settling time.

If the filter cartridge 932 becomes plugged, the device continues to function but at a lower efficiency. In that event, the liquid will accumulate and overflow to the inlet 970 of the conduit 950. The liquid will enter at 927, flow up to inlet 970 of the conduit 950, and effectively follow the same exit path as the airflow and exit out of outlet 960. Some solids separation is achieved by forcing the liquid to flow from the bottom to the top of the device.

As will be appreciated, the filtration assembly can include adsorbent media and/or ion exchange resins to assist in metal removal.

An optional feature is a stopper or plug (not shown) that may be engaged with and seal the inlet 970. When the inlet 970 is plugged, all air and liquid is drawn through the filter cartridge 932. Although the plug will cause the office vacuum level to be reduced, a greater driving force is provided to draw the liquid through the filter cartridge 932. The inlet 970 is plugged immediately prior to removing the device from the vacuum lines 108a,b for recycling. This operation drains as much liquid as possible from the device prior to shipping for recycling or waste disposal.

Advantages of the devices of the first and second embodiments include their simplicity. The devices have no electrical components and moving parts.

A third embodiment of a particle collection device 116 is shown in FIGS. 8A-C. The particle collection device includes a collection vessel 1000, an inlet port assembly 1004, a liquid valve assembly 1008, a baffle plate 1012, an outlet port assembly 1016, and a controller 1024.

The collection vessel 1000 includes a body housing 1026, and top and bottom plates 1028 and 1030.

The inlet port assembly 1004 comprises an inlet 1032 in communication with the vacuum line 108a and a 90° elbow 1034. The outlet port 1036 from the elbow 1034 points downwardly towards the bottom plate 1030 to prevent the incoming dental waste stream from impacting the liquid valve assembly 1008.

The liquid valve assembly 1008 includes first and second diaphragm holders 1040 and 1042, a diaphragm 1044 positioned between the holders, an air valve 1020, and air tubing 1047 extending from the air valve 1020 to the second holder 1040. The first diaphragm holder 1040 includes a plurality of ports 1046a-d for the passage of the gas and liquid phases. The gas phase passes through the ports normally (when the valve assembly 1008 is not activated). The liquid phase may pass through the ports when the liquid level rises, such as due to controller, air valve, and/or diaphragm valve assembly malfunction, to the level of the ports. The air valve 1020 is preferably a latching solenoid valve. This permits the controller 1024 to be able to run off of a pair of AA batteries for well over a year. The controller 1024 and valve 1020 may be replaced with a manual valve for a manually operated system.

The baffle plate 1012 is positioned between the inlet and outlet port assemblies 1004 and 1016 and extends from slightly below the bottom of top plate 1028 (leaving an air gap) to immediately below the screen 1050. The liquid phase is discharged on the side of the plate 1012 opposite from the side of the plate 1012 adjacent to the screen 1050. Among other things, the baffle plate 1012 directs airflow through the air gap at the top of the plate and liquid flow through the gap 1015 at the bottom of the plate. Although a flat baffle plate is depicted, it is to be understood that baffle plate can have a variety of shapes, including curved and cylindrical.

The outlet port assembly 1016 includes a liquid extraction screen 1050, first, second, and third conduits 1052, 1054, and 1056, a “T” 1057 engaging each of the first, second, and third conduits, a 90° elbow 1058 engaging the third conduit 1056, and an outlet 1060 engaging the vacuum line 108b. The second conduit 1054 is in engaged with the first holder 1040 and in fluid communication with the ports 1046a-d. The screen 1050 is designed to provide additional filtration of solids from the exiting liquid. The screen typically has a pore size ranging from about 20 to about 100 mesh (Tyler). High surface area filters and/or adsorbent media and/or ion exchange resins may also be employed as in the prior embodiments.

The controller 1024 monitors the state of the vacuum system via a pressure switch or sensor 1060 engaging the controller board 1024. The switch is set at a relatively low vacuum level, typically less than about 5 inches of mercury. The set point is selected so that the controller 1024 will know when the vacuum pump 112 is operating and will not be affected by fluctuations in the vacuum level in the vacuum hand pieces at each dental chair 104a-n. When the vacuum pump is activated and a predetermined period of time has passed since liquid was last removed from the vessel 1000, the controller 1024 causes the diaphragm valve assembly 1008 to close off the ports 1046a-d so that supernatant liquid will be drawn through the screen 1050, first and third conduits 1052 and 1056, elbow 1058, and outlet 1060 to the vacuum line 108b.

The operation of the device will now be described in greater detail with reference to FIGS. 8A-C and 9. With reference to FIG. 9, before step 1100 the vacuum pump 112 is deactivated and the liquid and solid phases of the dental waste stream previously discharged into the vessel 1000 separates through gravity settling.

In step 1100, the vacuum pump 112 is activated and the controller 1024 receives a signal from the pressure sensor or pressure switch 1060 indicating that the vacuum pump has been actuated. In decision diamond 1104, the controller 1024 determines whether or not the time interval since the vacuum pump was last deactivated is longer than a predetermined time interval. The time interval is selected to provide sufficient time for the solid phase to separate fully by gravity settling from the liquid phase. The time interval is typically at least about 5 hours, more typically at least about 8 hours, and even more typically at least about 10 hours. This logic prevents premature removal of the liquid phase of the waste stream during short periods when the vacuum pump 112 is cycled off and on. To determine when the vacuum pump is deactivated, a signal is received that the vacuum pump is deactivated so timing can start.

When the time interval is less than or equal to the predetermined time interval, the controller does nothing. In this mode of operation, the dental waste stream is discharged into the vessel 1000 through the inlet port assembly 1004. The liquid and solid phases collect in the lower portion of the vessel 1000 while the gas phase exits the vessel 1000 through the ports 1046a-d and ultimately the outlet 1060.

When the time interval is more than the predetermined time interval, the controller in step 1108 actuates the liquid valve assembly 1008 by opening the air valve 1020, thereby letting atmospheric pressure air contact the side of the diaphragm adjacent to the second holder 1042. The atmospheric pressure air deforms the diaphragm towards the ports 1046 and seats the diaphragm on the diaphragm orifice, thereby closing the ports 1046 to air flow. Closing the ports 1046 causes the vacuum pressure to draw liquid through the screen 1050 and into the conduit 1052 for ultimate discharge through the outlet 1060.

In decision diamond 1108, the controller 1024 determines whether the liquid has been withdrawn to a selected level or lower in the vessel 1000. This decision may be made in many ways. For example, a float switch or other liquid level detector may be used to detect the fluid level and provide the appropriate control signal to the controller 1024. Alternatively, the controller 1024 may assume that the appropriate amount of liquid has been removed when the air valve 1020 has remained activated (opened) for a selected period of time (such as from about 1 to about 10 minutes).

When the appropriate amount of liquid has been removed, the controller 1024 in step 1116 deactivates the air valve 1020, thereby causing the diaphragm to return to its original (unseated and open) position. A small vent hole in the diaphragm chamber of the second holder 1042 or along the tubing 1047 allows the diaphragm to relax. The vent hole may be protected from debris by a porous filter screen. Air is again drawn through the ports 1046 and liquid is not removed through the outlet port assembly 1016.

The various devices can have numerous operational benefits. For example, each of the devices allow the waste stream to be withdrawn by the vacuum pump 112 without a dedicated pump being required. The devices can ensure sufficient settling time has passed before allowing discharge of the wastewater, without the need for a timer. The devices can use large flow ports, thereby reducing the pressure drop across the device. The port geometry of the devices allows two or more units to be combined with simple external piping to provide a larger capacity particle collection system. The device can be effective at capturing about 95% of all particles that are greater than about 10 micron in size. This fraction of particles typically amounts to about 95% of the total mercury sent to the system. The devices can hold a vacuum when the vacuum pump is turned off. The device can remove fine amalgam particles that can damage the dental vacuum pump.

Installation of the device depends on the application. The device is designed to work with either wet- or dry-vacuum systems. In a dry-vac system, the device should be installed upstream of the dry vac's air/water separator. Differently sized clinics can be accommodated by adjusting the overall size of the device or providing a number of interconnected devices.

### The Line Cleanser Formulation

The line cleanser 120 formulation will now be discussed. As will be appreciated, the dental waste stream includes “dissolved” mercury-containing compounds and small (e.g., less than about 10 microns) amalgam particles. As used herein, “dissolved mercury” refers to mercury that passes through a 0.45-micron filter and includes soluble and colloidal forms of mercury. Soluble forms of mercury are typically present in the dental wastewater from the reaction of the mercury in amalgam particles with oxidants in the wastewater which release soluble forms of mercury into the wastewater. The most likely source of oxidants is bleach used in certain dental procedures and/or oxidizing agents in conventional line cleansers. Examples of soluble forms of mercury include elemental mercury, mercuric chloride, and mercuric oxide. “Colloidal forms of mercury” refers to forms of mercury that are intermediate between a true solution and a suspension. Colloidal forms of mercury typically have a particle size of between about 1 to about 100 nm. The line cleanser 120 facilitates the collection device 116 in the removal of these forms of mercury.

The line cleanser 120 includes one or more of a number of components, including an aggregating agent, a stabilizing agent, a cleaning agent, a buffering agent, a deodorizing agent, an anti-foaming agent, an antimicrobial agent, and a precipitating agent. The aggregating agent causes colloidal and suspended forms of mercury to coagulate and/or flocculate. As used herein, “coagulation” refers to irreversible and “flocculation” to reversible combination or aggregation of suspended colloidal particles. The stabilizing agent is included as necessary to maintain the effectiveness of the other components during storage. As will be appreciated, a “stabilizer” refers to a substance that tends to keep a compound, mixture, or solution from changing its form or chemical nature. Stabilizing agent may, inter alia, retard a reaction rate, preserve a chemical equilibrium, and act as antioxidants. The cleaning agent removes deposits from the vacuum lines 108. The buffering agent adjusts the pH of the line cleanser and/or dental waste stream to a desired range so as to optimize performance of the other line cleanser components. The deodorizing agent removes odors from the various waste stream components. The anti-foaming agent inhibits the formation of foam within the vacuum system. Foam can be caused, for example, by the addition of the cleanser to the vacuum lines. Excess foam can reduce the separation performance of the device 116 and degrade vacuum pump performance. The antimicrobial agent prevents the growth of microorganisms, such as bacteria, on filters, screens, and tubing. The precipitating agent causes soluble forms of mercury and other dissolved metals to precipitate as colloidal particles.

Aggregating and precipitating agents can aid mercury capture individually but are more effective when combined. While not wishing to be bound by any theory, the precipitating agent causes soluble forms of mercury to precipitate to form colloidal forms of mercury, and the aggregating agent agglomerates the colloidal forms of mercury to a separable particle size.

The aggregating agent is normally a compound that dissociates into strongly charged ions. The aggregating agent can be an inorganic or organic coagulant or flocculant or mixtures thereof. Examples of inorganic aggregating agents include multivalent metal salts, typically involving alumina, iron-alum, sodium aluminate, polyaluminum chloride, aluminum chlorhydrate, ferric chloride, ferric sulfate, copperas, lime and other calcium-bearing salts, and ammonium salts. Examples of organic aggregating agents include synthetic organic compounds such as polyelectrolytes, polyamines, polyquaternaries, poly diallyl-dimethyl ammonium chloride, epichlorhydrin, polyacrylamides (such as sold under the tradename C498-HMW™ of Cytec Industries, Inc.™), acrylamide copolymers, Mannich amines, polyacrylates, polyacrylate copolymers, quaternary ammonium salts (such as n-alkyl dimethyl benzyl ammonium chloride), and naturally occurring organic compounds, such as chitosan and moringa oleifera. Particularly preferred aggregating agents are nonionic and quaternary polymers that are generally less affected by pH. For some applications, a mixture of an organic and inorganic aggregating agents is beneficial, such as a mixture of a polymeric aggregating agent with an inorganic salt aggregating agent. Such a combination can enhance agglomeration and settling time. In a particularly preferred formulation, the aggregating agent is a quaternary ammonium salt sold under the tradename Stepan BTC-2125M™. This aggregating agent also possesses anti-microbial properties.

The line cleanser 120 preferably contains a sufficient amount of the aggregating agent to cause reversible or irreversible combination or aggregation of all or substantially all of the colloidal forms of mercury and mercury precipitates in the collected water stream. Preferably, the line cleanser includes from about 0.1 to about 50, more preferably from about 5 to about 40, and even more preferably from about 20 to about 30 weight percent of the aggregating agent.

The stabilizing agent is preferably an organic compound and more preferably is an alcohol, more preferably isopropanol, ethanol, and mixtures thereof, and even more preferably isopropanol. Isopropanol acts not only as a stabilizing agent but also as a cleaning agent. Preferably, the line cleanser includes from about 0.2 to about 20, more preferably from about 3 to about 20, and even more preferably from about 10 to about 20 weight percent of the stabilizing agent.

The cleaning agent can be a carbonate, bicarbonate, borate, surfactants, and mixtures thereof. The cleaning agent is typically compounded with an element from Group 1 of the Periodic Table of the Elements. A particularly preferred cleaning agent is sodium bicarbonate, which not only acts as a cleaning agent but also a buffering agent and deodorant. Preferably, the line cleanser includes from about 0.05 to about 5, more preferably from about 0.5 to about 2.5, and even more preferably from about 0.5 to about 1.5 weight percent of the cleaning agent.

The buffering agent can be any suitable buffering agent, such as a phosphate, hydroxide, bicarbonate, borate, and mixtures thereof. It is well established that pH can affect the form and concentration of metal species in water. pH can be important to maximize the effectiveness of the line cleanser 120. The buffering agent maintains the waste stream within the desired pH range. The desired pH range for the waste stream (when combined with the line cleanser) preferably ranges from about pH 5 to about pH 10, more preferably from about pH 7 to about pH 9.5, and even more preferably from about pH 8 to about pH 9.5. As will be appreciated, the precise pH range depends on the active components of the line cleanser 120, particularly the agglomerating agent. To realize this pH range, the total buffering agent concentration in the line cleanser preferably includes from about 0.1 to about 5, more preferably from about 0.1 to about 2.5, and even more preferably from about 0.5 to about 1.5 weight percent of the buffering agent.

The deodorizing agent can be any suitable deodorant. The deodorant removes or masks unpleasant odors by adsorption, by replacement, and/or by neutralization. Examples of deodorants include activated carbon, charcoal, chlorophyllin, pine oil, bicarbonate, and aluminum chlorohydrate. Preferably, the line cleanser includes from about 0.1 to about 5, more preferably from about 0.1 to about 2.5, and even more preferably from about 0.1 to about 1.0 weight percent of the deodorizing agent.

The antifoaming agent can be any suitable defoaming agent. Examples of defoaming agents include 2-octanol, sulfonated oils, organic phosphates, silicone fluids, dimethylpolysiloxane, glycol, fatty acids (such as coconut or tall oil), fatty alcohols, and mixtures thereof. Although some foam is desired for cleaning efficiency, a sufficient amount of antifoaming agent should be present to prevent foam build-up to the point where the device 116 is filled with foam. A particularly preferred antifoaming agent is a mixture of the defoaming agents sold under the tradenames Lubrizol Foamblast 168™ and Dow Chemical Dow L62™. Preferably, the line cleanser includes from about 0.15 to about 15, more preferably from about 2 to about 10, and even more preferably from about 5 to about 10 weight percent of the anti-foaming agent.

The antimicrobial agent can be any suitable substance having efficacy in killing or inhibiting the growth of microbes, such as bacteria. For example, the antimicrobial agent can include a cyclic ester, such as lactide and glycolide, strong acids and bases, and quaternary ammonium salts. Although oxidants and acids are effective anti-microbial agents, it is preferred that a non-oxidizing and non-acidic agent be used for reasons discussed elsewhere. The antimicrobial agent is preferably present in an amount effective to kill most (if not all) of the microbes in the vacuum system. Preferably, the line cleanser includes from about 0.1 to about 10 and more preferably from about 0.2 to about 1 weight percent of the antimicrobial agent.

The precipitating agent may be any suitable precipitant that can convert soluble metals into insoluble precipitates. Precipitating agents include metal, a trimercapto-s-triazine, sulfide salts, polysulfides (such as tetrasulfide), hydroxides, carbamates, thiocarbamates (e.g., sodium diethylthiocarbamate), polycarbamates, thiocarbanates, thioamides (e.g., thioacetamide), thiocarbamides, thiosulfides, thiourea, thioacetamide, thiocyanuric acid, iodates, and mixtures thereof. Caution must be exercised in selection of the precipitating agent so as not to introduce toxic components into the dental wastewater. A particularly preferred precipitant includes the product sold under the tradename TMT-15™ (which is a 15% solution of trimercapto-s-triazine and a trisodium salt). Preferably, the line cleanser includes from about 0.05 to about 5, more preferably from about 0.5 to about 2.5, and even more preferably from about 0.5 to about 1 weight percent of the precipitating agent.

The line cleanser is preferably substantially free or completely free of oxidants to minimize or inhibit the oxidation of elemental mercury and other metals and consequent inhibit the formation of soluble forms of mercury and dissolved metals. As used herein, an “oxidant” is a substance that gains electrons in an oxidation/reduction reaction with another substance. Preferably, the line cleanser includes no more than about 1 wt % and even more preferably no more than about 0.1 wt % oxidants.

In one formulation, the line cleanser can include a reductant to reduce mercury-containing compounds and materials to more easily removable elemental mercury. Reducing agents minimize oxidation and release of mercury from captured amalgam and help to chemically reduce incoming oxidized mercury, thereby making it less soluble. For example, reduced elemental mercury has a very low solubility—on the order of 20 micrograms/L.

A reducing additive should create a solution oxidation/reduction potential capable of reducing oxidized forms of mercury back to elemental mercury. The standard electrode potentials (E°) for mercurous (Hg₂⁺⁺+2c=2\overline{e}) and mercuric (Hg⁺⁺2\overline{e}=Hg) reduction are about +0.789 V and +0.854 V respectively. These are measured versus a standard hydrogen electrode. Thus to create a solution environment where the concentration of oxidized mercury is no greater than that for elemental mercury (the assumed minimum limit for a solution in contact with amalgam) the required potential is given by:

$$Eh = {E}^{°} + 0.059 log ( \frac{[ {Hg}_{oxidized} ]}{{a}_{Hg}} ) \qquad Eq . ( 1 )$$

at 25° C. In Equation (1), the activity of elemental mercury, a_{Hg}, is equal to unity by convention, and [Hg_{oxidized}] represents the molar concentration of oxidized mercury. The equation is exact if species activity is used in place of concentration. Assuming a desired maximum oxidized mercury concentration of about 5×10⁻⁸ molar (˜10 ppb), the solution Eh is preferably about ≦+0.36 V. In typical applications, the amount of reductant added will range from about 10 to about 1000 ppm.

Any suitable reductant can be used. Preferred reductants include stannous chloride, iron, tin oxalate, bisulfites, and/or polyvalent metals.

A preferred line cleanser formulation includes from about 1 to about 50 wt %, more preferably from about 5 to about 40 wt %, and even more preferably from about 10 to about 35 wt % of a quaternary ammonium salt acting as the aggregating and antimicrobial agents; from about 5 to about 20 wt % isopropanol as the stabilizing and cleaning agents; from about 0.1 to about 2.5 wt % sodium bicarbonate as the buffering, cleaning, and deodorizing agents; from about 0.5 to about 2.5 wt % Lubrizol Foamblast 168™ as an antifoaming agent; from about 5 to about 10 wt % Dow Chemical Dow L62™ as an antifoaming agent; and from about 0.1 to about 2.5 wt % Degussa TMT-15™ as the precipitating agent.

In a typical application, the cleanser 120 is initially in a concentrated form and diluted with water before introduction into the vacuum system. The typical dilution ratio typically ranges from about 10:1 to about 75:1 parts water: part concentrated line cleanser.

The process for manufacturing the line cleanser is relatively straightforward. The various components may be combined simultaneously or in any order and mixed thoroughly, such as using a ribbon blender. The less water soluble ingredients, such as antifoaming agents, are first mixed with the stabilizing agent and subsequently added to the aqueous components.

### Experimental

Amalgam separators are defined as items of dental equipment designed to retain amalgam particles carried by the wastewater from the dental treatment system, so as to reduce the number of amalgam particles and therefore the mercury entering the sewage system. The use of a centrifuge, filtration, sedimentation or combination of any of these methods may achieve separation of the amalgam particles.

ISO 11143 specifies requirements for amalgam separators used in connection with dental equipment in the dental treatment system. It specifies the efficiency of the amalgam separator (minimum of 95%) in terms of the level of retention of the amalgam based on a laboratory test. The standard also describes the test procedure for determining this efficiency, as well as requirements for the safe functioning of the separator, labeling, and instructions for use of the device. The ground amalgam sample for the efficiency test of the amalgam separator is divided into three different fractions:
6.0 g of particles sized 3.15 mm to 0.5 mm
1.0 g of particles sized 0.5 mm to 0.1 mm
3.0 g of particles smaller than 0.1 mm

In addition, 50% of the fine fraction particles should be less than 0.01 mm. The test sample used to assess the efficiency of the amalgam separator has a particle size distribution that reflects the situation found in dental treatment systems.

The particle collection device, which in one experiment was the device of the second embodiment and in another experiment the device of the third embodiment, was provided with a slurry including a defined mix of tiny amalgam particles. Copper particles were substituted for the more costly and potentially hazardous mercury amalgam particles. Copper has a density of about 9 g/cubic cm that is less than the density of amalgam, which is about 11 g/cubic cm. Thus, the test results were conservative. In the tests, the device of the second embodiment had a capture efficiency of from about 95 to about 99%, and the device of the third embodiment a capture efficiency of over 99%.

Two types of agglomerating agents were tested.

The first type is best represented by high molecular weight cationic polyacrylamide polymers. For example, using C498-HMW™ manufactured by Cytec Industries Inc., and overnight sedimentation, the flocculant consistently reduced the amount of mercury in dental waste stream samples as shown in FIG. 10. Flocculating agents, such as C498-HWM™, tend to produce low density flocs that often float in the waste stream.

The second type is a surface-active cationic agent such as quaternary ammonium salts. These compounds exhibit the ability to agglomerate and settle colloidal particles, producing a relatively dense, settled solid-phase. FIG. 11 shows the amount of mercury in several different dental waste stream samples categorized by the form of mercury persent: fine particulate (between about 10 and 0.45 micron), colloidal (between about 0.45 and 0.02 micron), and dissolved (less than about 0.02 micron). Large particles (greater than about 10 micron) were settled from the waste stream samples and removed before this experiment. The data indicate that, after removal of the large particles, the majority of the remaining mercury is in the form of fine and colloidal particles. FIG. 11 also displays the removal efficiency of a quaternary ammonium compound (n-alkyl dimethyl benzyl ammonium chloride) for the dental waste stream samples. The reagent is effective in removing virtually all of the suspended mercury and typically some of the dissolved mercury as well.

A further experiment was conducted to determine the effect of pH on quaternary ammonium salt performance. As can be seen from FIG. 12, for quaternary ammonium salts, an approximate pH of pH 8 to pH 9.5 is preferred.

Finally, FIGS. 13-14 show test data from four dental clinics. The data shown are averages obtained from several weeks of sampling. The same data is plotted on a linear (FIG. 13) and logarithmic (FIG. 14) scale. The data show the superior mercury removal realized when the particle collection device of the first or third embodiment is combined with the particularly preferred line cleanser formulation discussed above.

A number of variations and modifications of the invention can be used. It would be possible to provide for some features of the invention without providing others.

For example in one alternative embodiment, the diaphragm valve assemblies 216 and 1008 of the first and third embodiments of the device 116 can be different valve configurations. For example, the valve could be replaced by a movable piston seal in which a spring or elastic band positioned on a rear side of the piston resists closure of the piston against the seat. The closure force is provided by contacting the rear side of the piston with atmospheric pressure air, such as using the air valve 1020 and tubing 1047 configuration of FIG. 8A. When the atmospheric pressure is removed from the rear side of the piston, the resistive force of the spring or elastic band causes the piston to return to its original, unseated position, thereby reopening the valve.

In another alternative embodiment, the aggregating and/or precipitating agents are added to a conventional vacuum system cleanser. Typical dental line cleansers contain surfactants and disinfectants and may range in pH from acid to highly basic. Active ingredients include sodium hydroxide (Alprojet™), chloramine T (Tiutol™, Aseptoclean 2™), sodium perborate or another percarbonate, hydrogen peroxide (Orotol Ultra™), ammonium chloride (S&M matic™, Vacusol™), sodium hypochlorite (bleach), pyridine compounds (Green & Clean™), phosphoric acid (Purevac™), glycolic acid, citric acid, isopropanol, chlorhexidine gluconate (Biovac™), and/or enzymes (Vacukleen™).

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A contaminant removal system for treating a three-phase mercury-containing waste stream, the three phases comprising a gas phase, a liquid phase, and a solid phase, comprising:
a particle collection vessel for removing a particulate solid phase and a liquid phase from the three-phase effluent, the vessel being in communication with a vacuum pump and a receptacle adjacent to at least one dental chair, wherein in a first mode of operation at least most of the gas phase is removed from the vessel and at least most of the liquid and solid phases remains in the vessel, wherein in a second mode of operation at least most of the liquid phase is removed from the vessel and at least most of the solid phase remains in the vessel, and wherein, in each of the first and second modes of operation, the respective removed phase is removed by negative pressure generated by the vacuum pump.

2. The contaminant removal system of claim 1, further comprising a valve assembly and wherein the valve assembly is open in the first mode of operation to provide a first path of flow for the gas phase and closed in the second mode of operation to provide a second different path of flow for the liquid phase and wherein the first and second paths of flow overlap.

3. The contaminant removal system of claim 2, wherein the state of the valve assembly is determined by at least one a state of the vacuum pump and a pressure differential between a first pressure in contact with a first valve surface and a second pressure in contact with a second valve surface such that, when the pressure differential is less than a selected value, the valve assembly is in the open state and, when the pressure differential is more than the selected value, the valve assembly is in the closed state.

4. The contaminant removal system of claim 3, wherein the valve assembly comprises a diaphragm and wherein the first valve surface is a high pressure surface of the diaphragm and the second valve surface is a low pressure surface of the diaphragm.

5. The contaminant removal system of claim 4, wherein the diaphragm has an elasticity ranging from about 10 to about 70 shore A durometer.

6. The contaminant removal system of claim 4, further comprising a filtration assembly positioned in the second but not the first path of flow and wherein the filtration assembly comprises a filter having a pore size ranging from about 0.1 to about 20 microns.

7. The contaminant removal system of claim 6, wherein the filtration assembly comprises an open-ended conduit surrounding the filter and wherein the open end of the conduit is at a predetermined liquid level.

8. The contaminant removal system of claim 6, further comprising an output port assembly operable to remove the at least most of the liquid phase from the collection vessel and wherein the output port assembly comprises a flow restrictor positioned downstream of the filter along the second path of flow.

9. The contaminant removal system of claim 1, further comprising an input port assembly operable to introduce the waste stream into the collection vessel, wherein the waste stream has a first direction of flow when passing through a wall of the collection vessel and a second direction of flow when discharged into the collection vessel, wherein the first direction of flow is transverse to the second direction of flow, and wherein the input port assembly comprises first and second movably connected members through which the waste stream passes, the movable connection dampening discharge of the waste stream into the collection vessel.

10. The contaminant removal system of claim 2, further comprising a siphon assembly, wherein the siphon assembly is operational in the second mode of operation but not in the first mode of operation, and wherein the input port assembly comprises upper and lower outlets, the upper outlet passing the gas phase and the lower outlet passing the liquid phase.

11. The contaminant removal system of claim 10, wherein the operation of the valve assembly is determined by a liquid level in the particle collection vessel such that, when the liquid level is less than a selected liquid level, the siphon assembly is not operational and, when the liquid level is more than a selected liquid level, the valve assembly is operational.

12. The contaminant removal system of claim 2, wherein the valve assembly comprises a diaphragm and wherein the diaphragm is closed in response to the application of ambient external air pressure to a surface of the diaphragm and opened in response to the removal of the ambient external air pressure from the surface of the diaphragm and further comprising:
an air valve in communication with the surface of the diaphragm and providing the ambient external air pressure, the air valve being located exteriorly of the vessel;
a pressure sensor operable to determine a pressure within the collection vessel, the pressure being related to an operational state of the vacuum pump; and
a controller operable to control the air valve in response to the determined pressure within the collection vessel.

13. The contaminant removal system of claim 12, wherein the controller is further operable to (i) determine, based on the determined pressure from the pressure sensor, that the vacuum pump has been activated; (ii) when the vacuum pump has been activated, determine whether the time period since the vacuum pump was previously activated is greater than a predetermined time; and (iii) when the time period is greater than a predetermined time, switch the valve assembly from the open state to the closed state.

14. The contaminant removal system of claim 13, wherein, when the time period is less than the predetermined time, the controller maintains the valve assembly in the open state.

15. The contaminant removal system of claim 14, wherein the valve assembly is activated by the controller and the controller is further operable to (iv) determine whether a liquid level in the collection vessel is less than a selected level; (v) when the liquid level is less than the selected level, deactivate the valve assembly from the closed state to the open state; and (vi) when the liquid level is greater than the selected level, maintain the valve assembly in the closed state.

16. The contaminant removal system of claim 1, further comprising:
an input port assembly operable to introduce the waste stream into the collection vessel;
an output port assembly operable to remove the at least most of the liquid phase from the collection vessel; and
a baffle plate positioned between the input and output port assemblies, wherein at least most of the liquid phase flows through a gap beneath the baffle plate from the first to a second side of the baffle and wherein at least most of the gas phase flows through a gap above the baffle plate, the input port assembly being located on the first side and the output port assembly being located on the second side, whereby the baffle plate inhibits the at least most of the solid phase from being removed from the collection vessel by the output port assembly.

17. The contaminant removal system of claim 1, further comprising:
a line cleanser introduction device operable to introduce a line cleanser upstream of the collection vessel, the line cleanser being part of the liquid phase in the collection vessel and comprising at least two or more of the following components:
from about 0.1 to about 50 wt % of an aggregating agent;
from about 0.2 to about 20 wt % of a stabilizing agent;
from about 0.05 to about 5 wt % of a cleaning agent;
from about 0.15 to about 15 wt % of an anti-foaming agent; and
from about 0.05 to about 5 wt % of a precipitating agent.

18. A method for removing mercury-containing contaminants from a three-phase mercury-containing waste stream, the three phases comprising a gas phase, a liquid phase, and a solid phase, comprising:
(a) introducing the three-phase mercury-containing waste stream into a particle collection vessel, the vessel being in communication with a vacuum pump and a receptacle adjacent to at least one dental chair;
(b) during a first time interval, the vacuum pump removing at least most of the gas phase from the vessel while maintaining at least most of the liquid and solid phases in the collection vessel; and
(c) during a different second time interval, the vacuum pump removing at least most of the liquid phase from the vessel while maintaining at least most of the solid phase in the collection vessel.

19. The method of claim 18, wherein the first and second time intervals are nonoverlapping.

20. The method of claim 18, wherein, during the second time interval, at least most of the gas phase is removed, with the at least most of the liquid phase, from the collection phase.

21. The method of claim 18, further comprising:
(d) opening a valve assembly during the first time interval to provide a first path of flow for the gas phase; and
(e) closing the valve assembly during the second time interval to provide a second different path of flow for the liquid phase.

22. The method of claim 21, wherein, when a pressure differential across a valve member is less than a selected amount, the valve assembly is opened and, when the pressure differential is more than a selected amount, the valve assembly is closed.

23. The method of claim 22, wherein the valve assembly comprises a diaphragm and wherein a first pressure contacts a high pressure surface of the diaphragm and a second pressure contacts a low pressure surface of the diaphragm.

24. The method of claim 23, wherein the diaphragm is actuated by pressure differential of about 1.0 to about 15 psi.

25. The method of claim 23, further comprising:
(f) a filtration assembly removing at least some of the solid phase from the liquid phase during the second time interval and wherein the filtration assembly comprises a filter having a pore size ranging from about 0.1 to about 20 microns.

26. The method of claim 25, wherein filtration assembly comprises an open-ended conduit surrounding the filter and wherein the open end of the conduit is at a predetermined liquid level.

27. The method of claim 25, wherein an output port assembly removes the at least most of the liquid phase from the collection vessel and wherein the output port assembly comprises a flow restrictor positioned downstream of the filtration assembly along the second path of flow.

28. The method of claim 18, wherein an input port assembly operable introduces the waste stream into the collection vessel, wherein the waste stream has a first direction of flow when passing through a wall of the collection vessel and a second direction of flow when discharged into the collection vessel, and wherein the first direction of flow is transverse to the second direction of flow.

29. The method of claim 21, wherein step (c) comprises:
siphoning the at least most of the liquid phase from the collection vessel to an output port assembly to remove the at least most of the liquid phase from the collection vessel.

30. The method of claim 29, wherein the operation of the valve assembly is determined by a liquid level in the particle collection vessel such that, when the liquid level is less than a selected liquid level, the siphoning step is not performed and, when the liquid level is more than a selected liquid level, the siphoning step is performed.

31. The method of claim 19, wherein the valve assembly comprises a diaphragm and wherein the diaphragm is closed in response to the application of ambient external air pressure to a surface of the diaphragm and opened in response to the removal of the ambient external air pressure from the surface of the diaphragm and further comprising:
an air valve in communication with the surface of the diaphragm providing the ambient external air pressure, the air valve being located exteriorly of the vessel;
a pressure sensor determining a pressure within the collection vessel, the pressure being related to an operational state of the vacuum pump; and
a controller controlling the air valve in response to the determined pressure within the collection vessel.

32. The method of claim 31, further comprising:
the controller determining, based on the determined pressure from the pressure sensor, that the vacuum pump has been activated;
when the vacuum pump has been activated, the controller determining whether the time period since the vacuum pump was previously activated is greater than a predetermined time; and
when the time period is greater than a predetermined time, the controller activating the valve assembly from the open state to the closed state for a fixed period of time.

33. The method of claim 32, further comprising:
when the time period is less than the predetermined time, the controller maintaining the valve assembly in the open state.

34. The method of claim 33, wherein the valve assembly is activated by the controller and further comprising:
the controller determining whether a liquid level in the collection vessel is less than a selected level;
when the liquid level is less than the selected level, the controller deactivating the valve assembly from the closed state to the open state; and
when the liquid level is greater than the selected level, the controller maintaining the valve assembly in the closed state.

35. The method of claim 18, further comprising:
a baffle plate, positioned between input and output port assemblies, forcing at least most of the liquid phase to flow upward (versus gravity) to the output port assembly in the event of valve failure and/or system failure.

36. The method of claim 18, further comprising:
introducing a line cleanser upstream of the collection vessel, the line cleanser being part of the liquid phase in the collection vessel and comprising at least two of the following components:
from about 0.1 to about 50 wt % of an aggregating agent;
from about 0.2 to about 20 wt % of a stabilizing agent;
from about 0.05 to about 5 wt % of a cleaning agent;
from about 0.15 to about 15 wt % of an anti-foaming agent; and
from about 0.05 to about 5 wt % of a precipitating agent.

37. A vacuum line cleanser, comprising:
from about 0.1 to about 50 wt % of an aggregating agent;
from about 0.2 to about 20 wt % of a stabilizing agent;
from about 0.05 to about 5 wt % of a cleaning agent;
from about 0.15 to about 15 wt % of an anti-foaming agent; and
from about 0.05 to about 5 wt % of a precipitating agent, wherein the vacuum line cleanser is free of oxidants.

38. The cleanser of claim 37, wherein the aggregating agent is selected from the group consisting essentially of multivalent metal salts, aluminates, chlorides, chlorhydrates, ferric sulfate, copperas, polyelectrolytes, chitosan, nonionic polymers, quaternary polymers, polyamines, polyquaternaries, poly diallyl-dimethyl ammonium chloride, epichlorhydrin, polyacrylamides, acrylamide copolymers, Mannich amines, polyacrylates, polyacrylate copolymers, quaternary ammonium salts, moringa oleifera, and mixtures thereof.

39. The cleanser of claim 37, wherein the aggregating agent comprises at least about 1 wt % of a quaternary ammonium salt.

40. The cleanser of claim 37, wherein the stabilizing agent is an alcohol.

41. The cleanser of claim 37, cleaning agent is at least one of a carbonate, a bicarbonate, an alcohol, borate, and surfactants.

42. The cleanser of claim 37, wherein the precipitating agent is selected from the group consisting essentially of a trimercapto-s-triazine, a metal sulfide salt, a polysulfide, a hydroxide, a thiocarbamate, a thiocarbanate, a thioamide, a thiocarbamide, a thiosulfide, thiourea, thioacetamide, thiocyanuric acid, iodates, and mixtures thereof.

43. A vacuum line cleaning method, comprising:
introducing a line cleanser into a vacuum system, the line cleanser comprising:
from about 0.1 to about 50 wt % of an aggregating agent;
from about 0.2 to about 20 wt % of a stabilizing agent;
from about 0.05 to about 5 wt % of a cleaning agent;
from about 0.15 to about 15 wt % of an anti-foaming agent; and
from about 0.05 to about 5 wt % of a precipitating agent;
collecting the line cleanser and a three-phase waste stream from dental work in a particle collection vessel;
the particle collection vessel separating gas and liquid phases from a solid phase;
removing at least most of the gas and liquid phases from the collection vessel while maintaining at least most of the solid phase in the collection vessel.

44. The method of claim 43, wherein the cleanser is free of oxidants.

45. The method of claim 43, wherein the aggregating agent is selected from the group consisting essentially of multivalent metal salts, aluminates, aluminum chlorides, aluminum chlorhydrate, ferric sulfate, copperas, polyelectrolytes, chitosan, nonionic polymers, quaternary polymers, polyamines, polyquatemaries, poly diallyl-dimethyl ammonium chloride, epichlorhydrin, polyacrylamides, acrylamide copolymers, Mannich amines, polyacrylates, polyacrylate copolymers, quaternary ammonium salts, moringa oleifera, and mixtures thereof.

46. The method of claim 43, wherein the aggregating agent comprises at least about 5 wt % of a quaternary ammonium salt.

47. The method of claim 43, wherein the stabilizing agent is an alcohol.

48. The method of claim 43, cleaning agent is at least one of a carbonate, a bicarbonate, an alcohol, borate, and surfactants.

49. The method of claim 43, wherein the precipitating agent is selected from the group consisting essentially of a trimercapto-s-triazine, a trisodium salt, a metal sulfide salt, a polysulfide, a hydroxide, a thiocarbamate, a thiocarbanate, a thioamide, a thiocarbamide, a thiosulfide, thiourea, thioacetamide, thiocyanuric acid, iodates, and mixtures thereof.

50. The method of claim 43, wherein the line cleanser comprises a buffering agent, the buffering agent maintaining a pH of the combined liquid phase and line cleanser ranging from about pH 7 to about pH 9.
